(19) United States
(12) Patent Application Publication
(10) Pub. No.: US 2023/0077614 A1
(43) Pub. Date: Mar. 16, 2023

(54) Tubing RFID Systems and Methods

(71) Applicant: 2T Technologies, LLC, Houston, TX (US)

(72) Inventors: Maximo A. Tejeda, Houston, TX (US); Edgar Alejandro Zuniga, Houston, TX (US)

(73) Assignee: 2T Technologies, LLC, Houston, TX (US)

(21) Appl. No.: 17/931,443

(22) Filed: Sep. 12, 2022

Related U.S. Application Data
(60) Provisional application No. 63/242,559, filed on Sep. 10, 2021.

(51) Int. Cl. G06K 19/04; G06K 19/07

(52) U.S. Cl. CPC G06K 19/041; G06K 19/0723

(57) ABSTRACT

A system and method of embedding a radio frequency identification RFID tag on tubular strings, pipes, or casings by machining a groove or indention towards the end of the fadeaway of the upset. Because the RFID tag is permanently affixed to the coupling, the pipe is capable of being monitored or tracked at various points in its storage, travel, or use.

### CROSS-REFERENCE TO RELATED APPLICATIONS

This application is a continuation-in-part of, and claims priority to, pending U.S. Provisional Pat. Application 63/242,559, filed Sep. 10, 2021, the entire contents of which are hereby incorporated by reference.

### STATEMENT REGARDING FEDERALLY SPONSORED RESEARCH

Not applicable.

### BACKGROUND

We conceived a system and method of embedding a radio frequency identification (“RFID”) tag on tubular string, pipes, or casings by machining a groove or indention towards the end of the fadeaway of the upset. As used herein, “tubular”, “tubular string”, “pipe”, “piping”, “pipe string”, “casing”, and “casing string” are used interchangeable and other similar articles or objects are within the scope of the invention.

The use of an RFID wire tag is found best suited for the application, this simplifies machining and reduces costs. The RFID wire tags can be tailored to fit any diameter, size, or length desired. Various configurations of the RFID wire tag can be achieved such that the RFID chip disposed along the length of the wire such as an embodiment shown in FIG. 4 wherein the RFID chip is disposed between two lengths of antenna wire. Such an embodiment allows for the antenna to substantially encompass the circumference of a tubular when the RFID wire tag is embedded within a groove formed on a surface of the tubular. Other configurations can also be achieved such as placement of the RFID chip at a distal end of the RFID wire tag and a single antenna extending therefrom to substantially encompass a circumference of a tubular when embedded in a groove formed on a surface of the tubular. It should be appreciated that redundancy can be achieved in the described systems and methods using a plurality of RFID tags at points along the tubular, pipe, or casing, such as at either distal end of the tubular, pipe, or casing or at any point between the distal ends. Alternatively, some embodiments may implement a plurality of RFID tags each with the same identification credential, or with different identification credentials, at points along the tubular, pipe, or casing to provide redundancy in the described systems and methods herein. Alternatively, some embodiments may include one or more RFID tags at or on one or more couplings formed on or affixed to the tubular, pipe, or casing.

One is able to achieve correct readings and receipt of signals by a receiver from the RFID wire tag at distances of at least ten inches away and at any point in 360° circle around the RFID wire tag. The main objective of the RFID wire tag is to be able to have real-time data of the tubular, pipe, or casing being sent downhole or below ground.

The drilling or production rig can utilize the RFID technology to generate real-time tallies and inventory control as well as to access critical performance information of a particular tubular, pipe, or casing.

### SUMMARY

The purpose of this project is to improve the utilization, allocation and planning of tubulars, pipes, casings, and other oilfield assets across any enterprises, vendors, and service providers using the conceived systems and methods incorporating smart identification technologies in conjunction with Internet-accessible or cloud-enabled enterprise software, mobile applications, and Internet-of-Things (“IoT”).

The RFID systems and methods implemented on the tubular, pipe, or casing are preferably positioned at the upset are intended to be a long-term solution to inventory management and performance tracking over the lifetime of the tubular, pipe, or casing. In some embodiments, the RFID tag is embedded into a recessed grove designed to shield the RFID from damage and is permanently set into the coupling with a waterproof or liquid-resistant, corrosion and wear resistant epoxy.

In some embodiments, because the RFID tag is permanently affixed to the coupling, the pipe is capable of being monitored or tracked at various points in its storage, travel, or use. The RFID tag and associated data is logged into an inventory database upon receipt from the tubular, pipe, or casing manufacturer via a reading of the installed RFID tag. As the tubular, pipe, or casing is being loaded onto a truck or railcar for delivery to a field site to be employed in down hole services, a scan of the RFID tag updates the inventory database that the scanned tubulars, pipes, or casings are being moved. When the tubular, pipe, or casing is engaged and delivered into the down-hole assembly, the RFID tag is scanned and the inventory database is updated as to which piece is in which position on the string, and, correlates to the drilling data on how much torque was applied to that specific joint. The RFID tag installed on a tubular, pipe, or casing is scanned when it comes out of the hole, and the inventory database is updated to indicate that the piece has been removed from the bore and when it returns to the owner’s yard. The RFID tag can be scanned anytime the tubular, pipe, or casing is inspected, repaired, or otherwise acted upon and the inventory database can be updated to indicate various information about the inspection, repair, or other services, who performed the service, timing, and what that work entailed. If the coupling is changed, the RFID tag can be set to reference the previous RFID’s work orders so the remaining tubular body can keep any inspection and repair data associated to the new RFID tag.

In some embodiments, throughout the lifecycle of the tubular, pipe, or casing, the RFID tag and inventory database can provide a log of every time the tubular, pipe, or casing was updated in the inventory database, and why it was updated and who updated it.

In some embodiments, the correlation of check-ins, updates, and service logs, provides a novel view of what a tubular, pipe, or casing’s expected service life is or remains, and provides the operator or owner a better understanding of when preventive maintenance may need to be performed based on tracked usage, downtime, service time, couplings, and forces exerted upon the tubular, pipe or casing. The benefits of such described systems and methods can greatly reduce costs of expensive maintenance and repairs by allowing the operator and owners to conduct preventative maintenance. Further benefits include a reduction in avoidable incidents, which can save lives and avoid bodily harm to workers, by finding potential issues with a tubular, pipe, or casing through a data driven analysis implemented via the above systems and methods.

It should be appreciated that various types of materials such as plastics, woods, alloys, metals, polymers, among other materials can be used to form the tubulars. It should also be appreciated that the RFID tag can take various shapes and configurations while still embodying the scope and spirit of the present invention and achieve the same results. It should also be appreciated that materials other than epoxy, such as glues, polymers, resins, plastics, and other compounds can be used to fill the groove formed on a surface of a tubular and encapsulated an RFID tag while allowing an electromagnetic signal to be sent to or received from the RFID tag.

### BRIEF DESCRIPTION OF THE DRAWINGS

FIG. 1 depicts a plain view of one embodiment of the invention demonstrating a metallic tubular with an embedded RFID as described herein.

FIG. 2 depicts a side view of one embodiment of the invention as described herein.

FIG. 3 depicts an alternative view of one embodiment of the as described herein.

FIG. 4 depicts a top-down view of one embodiment of the RFID tag that may be used with the invention.

FIG. 5A depicts an alternative view of one embodiment of the invention demonstrating the depth and placement of the circumferential groove on the surface of the metallic tubular for embedding of the RFID tag and epoxy material as described herein.

FIG. 5B depicts an alternative cutaway side view of one embodiment of the invention demonstrating the depth and placement of the circumferential groove on the surface of the metallic tubular for embedding of the RFID tag and epoxy material as described herein.

### DETAILED DESCRIPTION

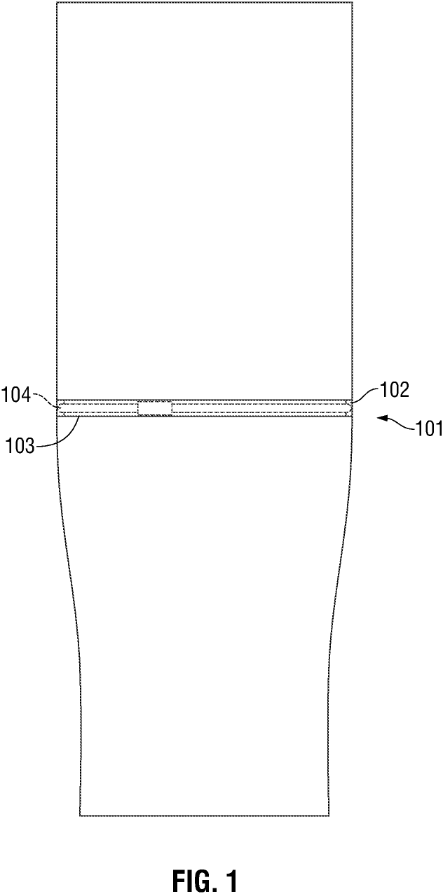

FIG. 1 shows one embodiment of the invention wherein metallic tubular 101 has a groove 102 formed on a surface of the metallic tubular wherein an epoxy material 103 fills in the groove 102 and further wherein an RFID wire tag 104 is embedded within the groove 102 and encapsulated by the epoxy material 103. The groove made be formed at the time the metallic tubular is made by including the groove. Alternatively, the groove may be formed after the metallic tubular is created by cutting, etching, routing, or other known act for removing material from a surface of a metallic tubular.

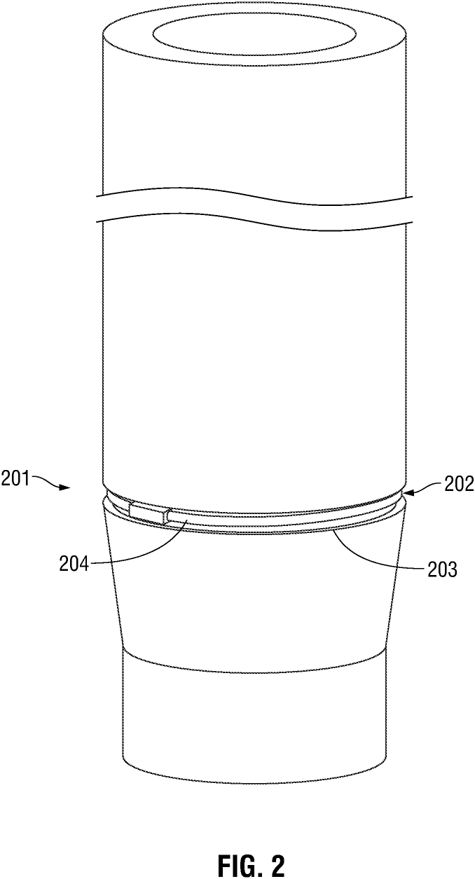

FIG. 2 shows one embodiment of the invention wherein tubular 201 having a groove 202 formed on a surface of the tubular wherein an epoxy material 203 fills in the groove 202 and further wherein a RFID wire tag is embedded within the groove 202 and encapsulated by the epoxy material 203.

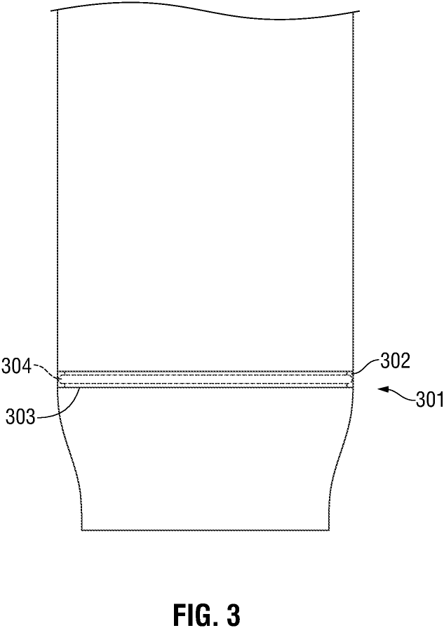

FIG. 3 shows one embodiment of the invention wherein metallic tubular 301 having a groove 302 formed on a surface of the metallic tubular wherein an epoxy material 303 fills in the groove 302 and further wherein an RFID wire tag 304 is embedded within the groove 302 and encapsulated by the epoxy material 303.

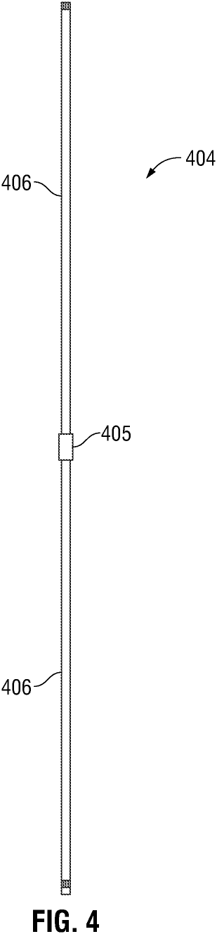

FIG. 4 shows one embodiment of the invention wherein RFID wire tag 404 that is not installed within a groove formed on a surface of a tubular and not encapsulated by an epoxy material. This embodiment depicts an RFID chip 405 and two antenna 406. It should be appreciated that alternative arrangements of the RFID wire tag can be made to achieve the same result as described herein. Such alternative arrangements can include placement of an RFID chip at a distal end of an RFID wire tag with a single antenna extending therefrom. Other arrangements may include a plurality of antenna and various configurations and placement of one or more RFID chips. The use of a plurality of RFID chips could be used for different types of information collection or even different vendors or servicers.

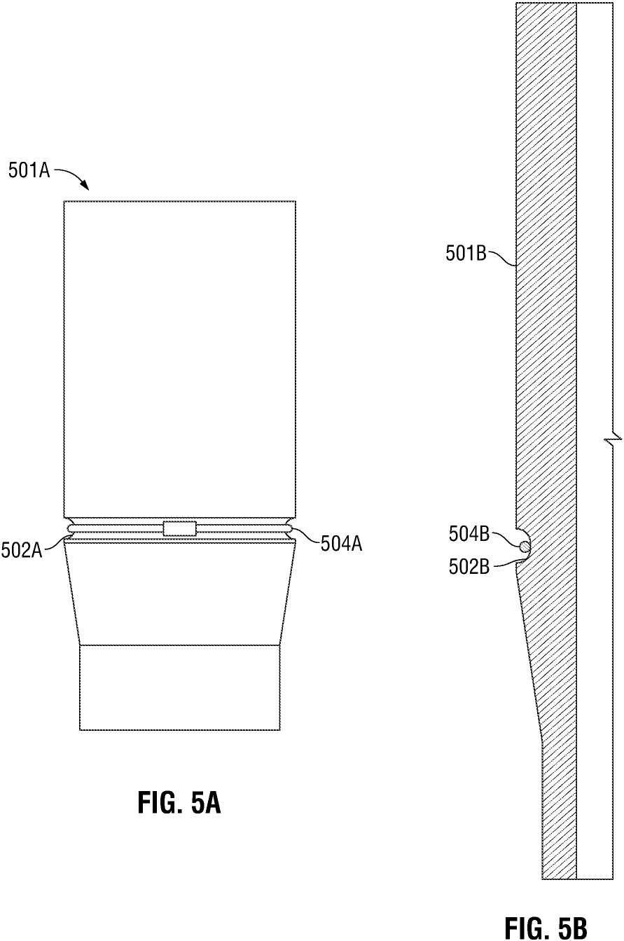

FIG. 5A shows one embodiment of the invention in which a side profile of the metallic tubular 501A has a groove 502A formed on an exterior surface of the metallic tubular wherein RFID tag 504A is placed within the groove 502A. FIG. 5B depicts a side cutaway view of metallic tubular 501B having a groove 502B formed on a surface of the tubular wherein an epoxy material would typically fill in the groove and further wherein an RFID wire tag 504B is embedded within the groove and is intended to be encapsulated by an epoxy material.

We claim:

1. An RFID device for monitoring use of a tubular comprising:
a tubular comprising a circumference having a first exterior surface having formed there on a groove;
an RFID tag comprising a wire disposed within the groove traversing a length of the circumference; and
an epoxy material disposed within the groove and encapsulating the RFID tag.
